(19) United States
(12) Patent Application Publication
(10) Pub. No.: US 2012/0207611 A1
(43) Pub. Date: Aug. 16, 2012

(54) CASTING LONG PRODUCTS

(75) Inventors: Axel Luckow, Mettmann (DE); Kevin Francis Carroll, Redditch (GB); Frederic Dartigues, Valenciennes (FR)

(73) Assignee: SOCIETE EUROPEENE DES TECHNOLOGIES DU TITANE ET DES ALLIAGES SPECIAUX SA., Jumet (BE)

(21) Appl. No.: 13/503,209

(22) PCT Filed: Oct. 21, 2010
(86) PCT No.: PCT/GB10/51776

§ 371 Date: Apr. 20, 2012

(30) Foreign Application Priority Data
Oct. 21, 2009 (GB) 0918457.3
Dec. 11, 2009 (GB) 0921654.0

(51) Int. Cl. B64C 27/46; B29C 39/42

(52) U.S. Cl. 416/223 R; 264/101; 264/485

(57) ABSTRACT

A method of production of a component having at least one dimension that is more than 200 mm, said method comprising the steps of: a) providing a titanium aluminide melt; b) providing a cold sand casting mould; c) mounting the mould and the melt in a vacuum or inert atmosphere chamber; d) rotating the mould at a distance from a rotation axis to generate an artificial gravity in all parts of the mould of at least 30 g; e) pouring the melt along said axis of rotation into a gateway that leads the melt to a radius greater than a maximum radius of any part of the mould, the gateway being arranged to open into the mould in a direction contrary to that of said artificial gravity; f) wherein said pouring is at a speed that fills the mould in less than 5 seconds. The method is useful for the casting of long turbine airfoils used in electricity generation industry or large automotive turbocharger wheels.

This invention relates to the casting of long and complex products such as turbine airfoils and turbocharger wheels made from titanium aluminide.

### BACKGROUND

Long products are difficult to cast and to achieve a low rejection rate. The same is true of complex parts. Here, “complex” means shapes that include re-entrants, whereby the shrinkage of the alloy after solidification imposes stresses on the material by virtue of the rigidity of the casting mould and sometimes to the extent that the elastic limit of the alloy is exceeded and the component cracks. Indeed, “complex” here is necessarily a somewhat vague term because dimensionally small re-entrants will frequently not be problematic. For example, the shrinkage over a small dimension may be within the limit of flexibility of the mould and not test the elastic limit of the cast product. When magnified however, the same geometric re-entrant may be exceedingly problematic. Airfoils used in turbines for the generation of electricity are a case in point. Gas turbine electricity generators have specific requirements to meet the demands of high efficiency. Thus, they need to run at high speed and high temperature. The high temperature is limited by the capacity of the metal to maintain strength. Even so, hollow airfoils for cooling purposes can increase the capacity of the metal to maintain strength at high operating temperatures. The disadvantage of such cooled airfoils is that the cooling air has to be taken off the compressor resulting in loss of energy efficiency. Speed is limited by the capacity of the airfoil to resist the forces involved. The strength of the airfoil also limits its size. Airfoils in excess of 400 mm length are desirable, but need to be of a composition that can withstand the forces involved. Airfoils are of complex three dimensional shape to maximize efficiency in transfer of energy of a hot moving gas to rotational energy of a turbine. They generally have a root that is a flange at one end of the airfoil and desirably often a shroud at the other end of the airfoil. These stretch the airfoil during solidification and subsequent cooling if the mould itself does not shrink. The extent to which this is a problem depends on the alloy employed. Airfoils for turbine engines have similar problems. Fundamental, therefore, is the material employed to make an airfoil and the method of its construction.

In a quite different field, large vehicles enjoy the benefits of turbochargers as do smaller vehicles, but the stresses imposed on turbocharger axial flow or radial flow wheels increases with increasing size. It would be desirable to make larger turbocharger wheels from materials that are lighter and yet still have sufficient strength and heat resistance.

Titanium aluminide intermetallics offer suitable characteristics of strength, ductility and temperature resistance for use as a turbine airfoil. However, a particular issue with titanium aluminide is that, in the liquid phase, the alloy is highly reactive. Consequently, casting titanium aluminide is problematic in that surface reactions with a casting mould adversely affect the surface properties of the casting.

This is particularly the case with ceramic investment casting. This is the normally preferred form of casting; it provides the best “net-shape” castings, that is, the shape of casting nearest the desired final shape and requiring the least further working. Further working may compromise surface finish. With the common static investment casting processes, it is usually necessary to use hot ceramic moulds. This ensures that the liquid metal fully fills the mould cavity without misrun defect. That is caused by heavy temperature loss of the liquid metal and premature solidification prior to the mould cavity being fully filled. However, this greatly exacerbates the mould reaction problem, and with titanium aluminide the process does not work because of the chemical reaction between the aluminide and ceramic.

Long products are particularly difficult to manufacture. Some materials, but in particular titanium aluminides, are extremely brittle at room temperature, and have the feature of considerable shrinkage during solidification and cooling. These features lead to form cracking, shrinkage porosity and misrun defects. Indeed, the longer the product, the more severe is the tendency to form cracking, shrinkage porosity and misrun defects, and the longer the metal must remain in the liquid phase during casting. This in turn promotes surface reaction between the liquid metal and mould materials. Whilst, using hot moulds to some extent counteracts the shrinkage problem (because the mould itself shrinks also as it cools) this is firstly not usually adequate and secondly suffers the problem of mould reaction just mentioned above.

U.S. Pat. No. 5,284,620 discusses titanium aluminide alloys and their investment casting employing boride dispersoids to refine grain sizes to between 50 and 250 microns in a preheated ceramic mould. However, the use of titanium aluminide in a preheated ceramic mould, even with a zirconia face coating, leads to severe titanium aluminide/mould reaction making it impossible to cast these alloys successfully in ceramic shells. The route most currently explored is to find other face-coatings that are not reactive with titanium aluminide and yttrium oxide is one, rather expensive candidate.

US-A-2004/0040690 discloses centrifugal casting of titanium alloys in ultra-fine grained machined isotropic graphite moulds at room temperature and at up to 150 g of artificial gravity. Centrifugal tubular castings can be made of any required length, thickness and diameter. Simultaneous rotation of a tree of moulds located along the perimeter of a circle on a horizontal plane while melt is being poured into a central downsprue lying along the vertical axis of the tree creates high velocity flow of melt under the action of centrifugal force. However, it would be impossible to produce titanium aluminide castings having a complex shape in a rigid, machined graphite mould without cracking due to the substantial coefficient of expansion of titanium aluminide and the resultant shrinkage this implies on cooling.

It is an object of the present invention to alleviate the above mentioned problems, or at least mitigate their effects, so that a complex product, such as a turbine airfoil in excess of 200 mm in length, and preferably in excess of 500 mm, or a turbocharger turbine wheel in excess of 200 mm diameter, can be cast from titanium aluminides, and without significant surface reaction, cracking and minimized shrinkage porosity. In particular, it is an object to produce long product having flanged ends such as turbine airfoils that are particularly susceptible to the problem of shrinkage causing cracking. The object is further to achieve this in a cost-effective manner so that it can be exploited on an industrial scale.

### BRIEF SUMMARY OF THE DISCLOSURE

In accordance with the present invention there is provided a component comprising a sand-cast titanium aluminide turbine airfoil in excess of 200 mm long, and preferably in excess of 400 mm long, more preferably in excess of 500 mm long.

The term “titanium aluminide” is used herein, unless the context dictates otherwise, to cover all titanium aluminides, including alloys of titanium aluminide.

Titanium aluminides and titanium alloys are different kinds of materials. This is because titanium aluminides are ordered intermetallic compounds with fixed atomic ratio, for example, the ratio for gamma-titanium aluminide (γ-TiAl) is 1 titanium atom to 1 aluminium atom in L10 ordered tetragonal crystal structure and the ratio for alpha2-titanium aluminide (α2-Ti3Al) is 3 titanium atoms to 1 aluminium atom in D019 ordered bcc crystal structure. This ordered intermetallic structure is inherent and quite different to the properties of titanium alloys. For example, γ-TiAl possesses fixed high melting point at 1460° C., low ductility at ambient temperature and good high-temperature strength, when compared with titanium alloys. In recent years, considerable development of titanium aluminide materials has been made by adding other elements or by process control to improve or optimize properties for specific applications. Nevertheless, the basic structure of titanium aluminides remains the same, i.e. they are ordered intermetallic compounds. Titanium aluminides are extremely difficult to cast due to their brittle nature. This substantially also applies to alloys of titanium aluminide.

A suitable titanium aluminide alloy is Ti46Al8Nb (at. %). A published paper: “Microstructures and tensile properties of massively transformed and aged Ti46Al8Nb and Ti46Al8Ta alloys” by H. Saagea, A. J. Huanga, D. Hua, M. H. Lorettoa and X. Wu, INTERMETALLICS, Volume 17, Issues 1-2, January-February 2009, Pages 32-38 reports this alloy in public domain. Another suitable titanium aluminide alloy is Ti-45Al-2Nb-2Mn (at. %).

Titanium alloys, on the other hand, are metallic materials which contain generally a majority of titanium mixed with other chemical elements. The other elements exist in solid solution state; the atoms of the other elements replace or occupy interstitial positions between the atoms of the titanium. The crystal structure of titanium alloys is non-ordered and the solid solubility of the other elements can vary dramatically with temperature. Normally, titanium alloys possess a range of melting temperature, good ductility at ambient temperature, and their strength deteriorates significantly at high temperature. Titanium alloys can have wide range of compositions and are relatively easily cast.

Also in accordance with the present invention there is provided a component comprising a sand-cast titanium aluminide turbocharger turbine wheel in excess of 200 mm in diameter.

Sand casting is a traditional method of casting metal. However, it has been superseded by investment casting of precision product where near-net shape is desired to minimise further work after casting and which is often regarded as detrimental to alloy properties.

Preferably, said components are made in a method of production comprising the steps of:

a) providing a titanium aluminide melt;

b) providing a cold sand-casting mould;

c) mounting the mould and the melt in a vacuum or inert atmosphere chamber;

d) rotating the mould at a distance from a rotation axis to generate an artificial gravity in all parts of the mould of at least 30 g (preferably 50 g), (that is to say an acceleration at least equivalent to a rotation at 120 rpm at a radius of 1.2 m, preferably 150 rpm and/or at a radius of 1.5 m);

e) pouring the melt along said axis of rotation into a gateway that leads the melt to a radius greater than a maximum radius of any part of the mould, the gateway being arranged to open into the mould in a direction contrary to that of said artificial gravity;

f) wherein said pouring is at a speed that fills the mould in less than 5 seconds.

In one embodiment, the sand mould uses graphite-coated sand to provide high wetability resistance to the liquid metal, as well as high heat conductivity. This ensures production of castings with good surface finishing. The graphite in the sand mould also provides an inert atmosphere during casting to prevent mould reaction. The graphite sand mould provides high thermal conductivity resulting in fast cooling to reduce mould reaction and produce the requisite fine grain structure.

The term “cold” means a temperature less than 100° C. Some warmth (for example a temperature in excess of 50° C.) is desirable to ensure that moisture in the sand is driven off.

The sand mould is preferably made with controllable mould strength and flexibility. Preferably, the mould is slotted between flanges of long components, whereby collapse of the mould occurs at forces imposed on it in excess of those experienced during casting but less than applied by the product during shrinkage and within its elastic yield strength. This ensures the casting contraction without cracking during solidification and subsequent cooling down. Of course, although it might be feasible to provide machined solid-graphite moulds with controlled strength, such would be entirely uneconomic since the machining of a new mould each time would be too expensive for mass production of hundreds/thousands of parts.

The sand mould is poured in room temperature to reduce mould reaction and produce fine grain structure.

The mould being filled counter to the direction of said artificial gravity provides steady filling without air entrapment to ensure substantially inclusion-free casting.

Preferably, the moulds are disposed on a pouring table up to three meters in diameter. Preferably, up to one ton alloy ingot is melted in said chamber, thereby to enable production of titanium aluminide castings of the desired size on mass production scale. Said melting is preferably by arc melting, resulting in low superheating, so that the melt is only some 50° C. above the alloy's melting point. This does lead to some solidification of metal in its transfer between the crucible and the mould, but an aspect of the present invention is the swiftness of the centrifugal casting that reduces the opportunity for solidification to such an extent that complete filling of mould is assured. Vacuum induction melting is also a possible method of melting.

In another embodiment, the sand mould supports a ceramic investment shell which, in the especial case of titanium aluminide alloys, comprises crumple zones to accommodate significant cooling contraction rate of the cast alloy.

The apparent high density of metal under such gravitational loads has two effects. The first is that, despite a rapid filling regime, the high gravity results in a very smooth laminar flow when effected contrary to the gravitational direction. Second, all loose inclusions and gas bubbles, that are generally a disadvantage with sand moulds, are swept up with the advancing liquid front so that they do not feature in the product in the mould. Indeed, preferably, a capture zone exists radially internally of the mould and into which such inclusions are swept but which are later separated from the product.

Traditional sand moulds are hitherto considered to leave an unacceptably rough surface. However, with little surface degradation due to the rapid cooling and solidification of the alloy, surface defects can easily be removed by machining, such as by grinding, and, in any event, generally less surface treatment is required than with products cast by other processes where significant surface degradation may have occurred by reaction with the mould. The construction of suitable sand moulds is within the current ability of those skilled in the art and does not need further description herein. However, preferably, said graphite coated sand is produced from a composition comprising, by weight:

| | |
|---|---|
| graphite | 15-25% (18-23) |
| inorganic binder | 5-20% (7-12) |
| sand | 55-80% (65-75) |

the amounts in brackets being preferred amounts.

Preferably, said binder comprises, by weight of the total composition:

| | |
|---|---|
| sodium silicate | 3-10% (4-7) |
| water | 5-12% (3-6) |

preferred amounts being in brackets. Preferably, the graphite is finely divided and mixed with the sand and sodium silicate binder by dry-blending, whereupon the water is added and the mixture wet-rolled to break down the graphite into an emulsion that coats the sand grains.

By varying the quantity of the graphite, the thermal conductivity of the blend is varied, whereby the rate of cooling of the mould can be varied. By varying the quantity of the binder, the rigidity of the blend, after baking, can be varied.

Preferably, where the part to be cast has in a region a thin section, the thermal conductivity of the mould in that region is reduced compared another region of the part to be cast that has a thicker section.

Preferably, where the part to be cast has a re-entrant of significant length, comprising a long side and two ends, preferably at least a part of the mould between said ends comprises a blend with less binder than in other parts of the mould, whereby contraction of the part on cooling crushes the mould between said ends without itself cracking.

Alternatively, slots may be formed in the mould so that a bridge of sand across the end of the slot next to the long side of the part to be cast is not sufficiently strong to withstand the contraction forces of the part shrinking during cooling, although it is strong enough to withstand the forces imparted during casting.

As noted above, if particular near-net shape is required, and that cannot be achieved with a sand mould, the present invention includes the possibility of a ceramic shell being employed that is supported in sand. This means that the shell can be relatively thin, since it is mechanically supported by the sand. This also means that the high conductivity of the graphite-coated sand is exploited, which leads to the rapid cooling that is essential with titanium aluminides to avoid undesirable reactions, (although also desirable with other alloys for the reason of a more favourable micro-structure). However, the shell cannot be so thin that it cracks and breaks uncontrollably when the product shrinks during solidification of the alloy. For this purpose, known crumple zones are provided. Preferably, the ceramic mould is face-coated with zirconia. Other face-coatings are of course possible, some of which (eg yttrium oxide) will improve surface properties of the cast part, but are commensurably more expensive.

### BRIEF DESCRIPTION OF THE DRAWINGS

Embodiments of the invention will now be described, by way of example only, with reference to the accompanying drawings, in which:

FIG. 1 is a schematic cuta-away view of apparatus suitable for use in the present invention;

FIG. 2 is a side section through the downsprue, gateways and moulds of apparatus suitable for use in the present invention;

FIG. 3 is a view in the direction of the Arrow A in FIG. 2; and

FIG. 4 is a section through a typical sand mould.

### DETAILED DESCRIPTION

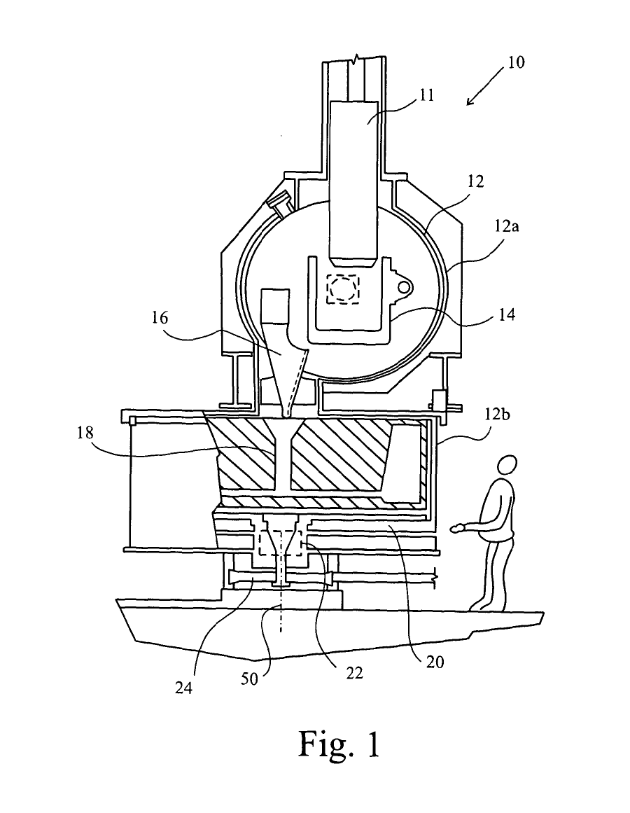

Referring now to FIG. 1, apparatus 10 comprises a sealed chamber 12 in two parts, an upper section 12a and a lower section 12b. The chamber houses a titanium aluminide ingot electrode 11 that can be advanced (by a mechanism not shown) towards a water-cooled copper crucible 14. The chamber 12 is evacuated to a vacuum of about 0.1 mm Hg. An arc is developed between the electrode and crucible. This progressively melts the alloy of the electrode at a substantial rate as the electrode is advanced, so that a melt of about 1000 kg can be developed in the crucible in about 30 minutes. When melted and temperature stabilized, the crucible is tipped so that the melt pours into a tundish 16 that guides the melt into a central down sprue 18 that is part of a rotatable table 20 within the lower section 12b of the chamber 12. The table 20 is mounted on bearings and seals 22 in the base of the chamber 12 and a shaft extends through a wall of the chamber to a flywheel pulley 24 that is driven to rotate the table at about 100 to 150 rpm (eg about 120 rpm) about a rotation axis 50 by any suitable means such as a belt. At 1.5 m radius, this results in an artificial gravity of between 24 and 37 g.

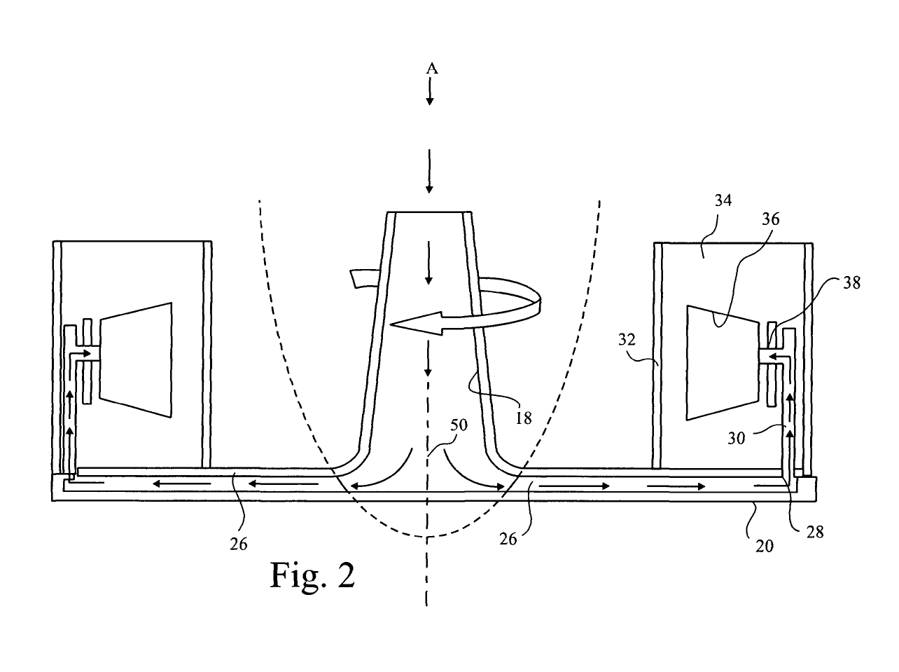

In FIG. 2, the downsprue 18 is coned so that, as melt progresses down it under the influence of normal earth gravity, and as it begins to rotate through frictional contact with the wall of the downsprue 18, the centrifugal effect maintains the melt in contact with the wall and throws it outwardly, and thereby progressively downwardly, assisting earth gravity. Also it ensures an even distribution of the melt around the inside of the downsprue.

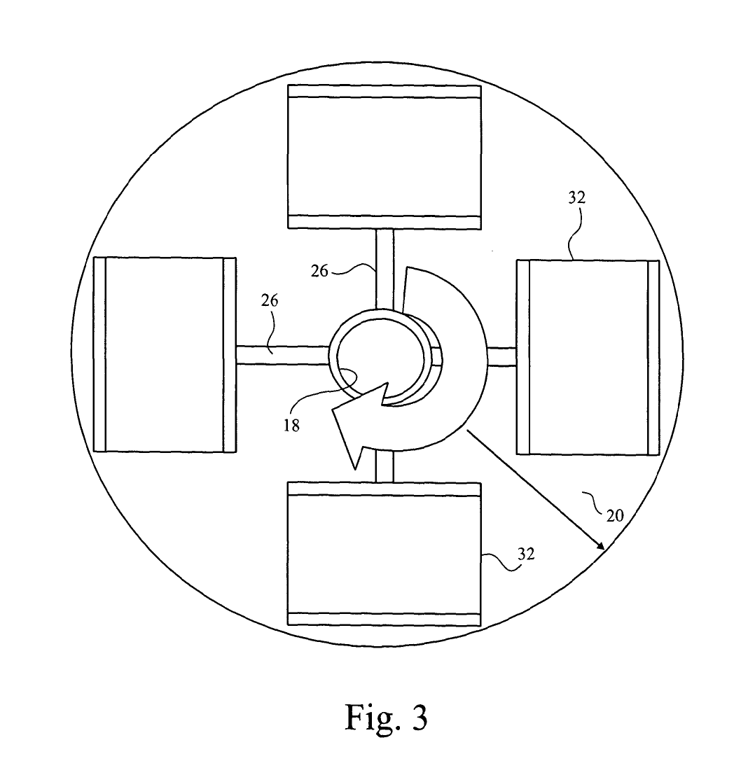

When the melt reaches the bottom of the down sprue 18, it encounters a plurality of gateways 26 (four of them in FIG. 3), along which the melt rushes under the influence of the artificial, rotation induced, gravitational force. At a maximum diameter of the table 20, the gateways terminate at a junction 28 where the passageway turns into a vertical leg 30 within a mould box 32. Within the mould box 32 is sand 34 defining a mould cavity 36. An entry 38 to the cavity 36 is at the maximum diameter so that, when metal enters the mould it does so in the opposite direction to the direction of the artificial gravity, which is all but perpendicular to the axis of rotation 50.

However, the mould 36 is constructed with a sand blend comprising about 70% Oviline sand, 20% finely divided graphite particles, and 5% sodium silicate powder. This is achieved by dry blending and then wetting the mixture with about 5% of water (all percentages being by weight of the total composition) before wet rolling to grind the graphite into an emulsion that wets and coats the sand particles with graphite. After forming a first mould half 54 (see FIG. 4) by pressing the sand around a suitable pattern within a box, the so-formed half-mould is baked in an oven to cure the sodium silicate so that it binds the blend together. The other side of the pattern is pressed into a separate batch of sand to form a second half 56 of the mould that is then mated with the first mould half to form the final mould, which is then inserted in the steel box 32 that supports the mould under the forces experienced during centrifugation. A joint line 58 results between the mould parts.

Alternatively, the mould may be lined with a ceramic investment casting shell 60 (partly shown as a possibility in FIG. 4). In this event, the sand is packed around the shell. While the shell 60 can be arranged relatively thin compared with a normal, unsupported shell, it still needs sufficient strength to avoid collapse at critical locations during solidification. Crumple zones 62 can be provided at non-critical locations to accommodate shrinkage. These are shown in FIG. 4 as a simple thinning, but more sophisticated crumple zones are achieved by engineering voids in the ceramic shell. Nevertheless, the shell can otherwise be substantially thinner than normal and this enables rapid heat transfer to the sand, resulting in rapid solidification improving grain structure and reducing mould reaction. The use of a ceramic shell in this instance enables near-net shapes to be achieved with reduced surface degradation caused by reaction of the liquid metal with the shell material. Furthermore, generally desirable microcrystalline structure with grains sizes typically less than 500 microns can be achieved, although this does depend on the alloy and application.

Indeed, while the filling of the moulds may be rapid, by counter-filling with respect to the radial, artificial gravity direction, and the substantial gravitational forces experienced, the flow is laminar and smooth on entry to the mould and that prevents significant turbulence that can disrupt the internal surface of moulds leading to spalling of the surface and inclusions of debris. Any loose sand grains are swept away by the advancing front and again, the high gravitational force enhances any density variations ensuring that light material is not included in the moulded product. Consequently, a low rejection rate results.

Returning to FIG. 4, the present invention is primarily concerned with titanium aluminides that are being cast in long product, particularly in a form having a re-entrant shape, that is to say, a complex shape having forms in the three orthogonal directions and so that there are two end anchors and a strip between. In these circumstances, the forces imposed by contraction between the anchors may be greater than the ultimate tensile strength of the material. In FIG. 4, a turbine airfoil 70 to be cast has end flanges 72,74 that precisely form anchors in the mould 36, separated by a long side 76. The long side is desirably 400 mm or more in length. However, other forms such as cooling passages in turbine airfoils likewise form re-entrants, as do turbocharger wheels, particularly large ones. To accommodate the stresses involved in these regions after casting, the crumple zones 62 might be provided as described above and where a ceramic shell is employed. Alternatively, or in addition, slots 78 may be formed in the mould having a frangible bridge 80 between the slot and the long side 76. When the long side contracts, the slots collapse protecting the component.

However, not all re-entrants are as obvious as that illustrated, and sometimes it is desirable that the mould be complete and, instead of slots being provided, the mould is formed at specific locations of a sand blend with less sodium silicate so that it crushes and deforms under shrinkage forces.

A similar capacity for adjustment to accommodate local issues in the product being cast is provided by varying the graphite content of the blend at specific areas of a casting, for example where the component is thin and consequently might solidify too soon causing a misrun if the preferred graphite content and cooling rate was employed throughout the mould.

Construction of a mould using varying blends of sand therefore enable the mould to be provided with different characteristics suitable for particular forms to be cast.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A component comprising a sand-cast titanium aluminide turbine airfoil in excess of 200 mm long.

2. A component of claim 1, wherein the turbine airfoil is at least 400 mm long, preferably in excess of 500 mm long.

3. A component comprising a sand-cast titanium aluminide vehicle turbocharger turbine wheel in excess of 200 mm in diameter.

4. A component of claim 1, comprising an alloy that is one of:
a) Ti-46Al-8Nb (at. %)
b) Ti-45Al-2Nb-2Mn (at. %) and
c) Ti46Al8Ta (at. %)

5. A method of production of a component of claim 1, comprising the steps of:
a) providing a titanium aluminide melt;
b) providing a cold sand-casting mould;
c) mounting the mould and the melt in a vacuum or inert atmosphere chamber;
d) rotating the mould at a distance from a rotation axis to generate an artificial gravity in all parts of the mould of at least 20 g the artificial gravity comprising an acceleration at least equivalent to a rotation at 120 rpm at a radius of 1.2 m;
e) pouring the melt along said axis of rotation into a gateway that leads the melt to a radius greater than a maximum radius of any part of the mould, the gateway being arranged to open into the mould in a direction contrary to that of said artificial gravity;
f) wherein said pouring is at a speed that fills the mould in less than 5 seconds.

6. A method of claim 5, wherein the sand mould comprises graphite-coated sand to provide at least one of:
relatively high wetability resistance to the liquid metal;
relatively high heat conductivity to accelerate cooling to reduce mould reaction and give a fine grain structure; and
relatively inert atmosphere during casting to prevent mould reaction,
all such relativities being with respect to uncoated sand.

7. A method of claim 5, wherein the temperature of the mould before casting is between 50° C. and 100° C.

8. A method of claim 5, wherein the sand mould supports a ceramic investment shell which comprises crumple zones to accommodate significant cooling contraction rate of the cast metal.

9. A method of claim 8, wherein said ceramic investment shell is face coated with zirconia.

10. A method of claim 5, wherein sand mould is made with controllable mould strength and flexibility.

11. A method of claim 10, wherein the mould is slotted, whereby collapse of the mould occurs at forces imposed by the product in excess of those experienced during casting but within the elastic yield strength of the solidifying cast product.

12. A method of claim 5, wherein the moulds are disposed on a rotating pouring table up to three meters in diameter.

13. A method of claim 5, wherein up to one ton ingot is melted in said chamber, thereby to enable production of titanium aluminide castings of the desired size on mass production scale.

14. A method of claim 5, wherein said melting is by arc melting, resulting in low superheating, and whereby the melt is between 40 and 60° C. above the titanium aluminide's melting point.

15. A method of claim 6, wherein said graphite coated sand is produced from a composition comprising, by weight:

| | |
|---|---|
| graphite | 15-25% |
| inorganic binder | 5-20% |
| sand | 55-80%. |

16. A method of claim 15, wherein said graphite coated sand is produced from a composition comprising, by weight:

| | |
|---|---|
| graphite | 18-23% |
| inorganic binder | 7-12% |
| sand | 65-75%. |

17. A method of claim 15, wherein said binder comprises, by weight of the total composition:

| | |
|---|---|
| sodium silicate | 3-10% |
| water | 5-12% |

18. A method of claim 17, wherein said binder comprises, by weight of the total composition:

| | |
|---|---|
| sodium silicate | 4-7% |
| water | 3-6% |

19. A method of claim 17, wherein the graphite is finely divided and mixed with the sand and sodium silicate binder by dry-blending, whereupon the water is added and the mixture wet-rolled to break down the graphite into an emulsion that coats the sand grains.

20. A method of claim 15, wherein the quantity of the binder is varied to vary the rigidity of the blend, after baking, whereby localised crumple zones can be formed in the mould.

21. A method of claim 5, wherein the quantity of the graphite employed is varied to vary the thermal conductivity of the blend, whereby the rate of cooling of the mould can be varied.

22. A method of claim 21, wherein the part to be cast has a region of thin section and the thermal conductivity of the mould in that region is reduced compared another region of the part to be cast that has a thicker section.

23. A method of claim 20, wherein the part to be cast has a re-entrant of significant length, comprising a long side and two ends, and at least a part of the mould between said ends comprises a blend with less binder than in other parts of the mould, whereby contraction of the part on cooling crushes the mould between said ends without itself cracking.

24. A method of claim 20, wherein the part to be cast has a re-entrant of significant length, comprising a long side and two ends, and slots are formed in the mould so that a bridge of sand across the end of the slot next to the long side of the part to be cast is strong enough to withstand the forces imparted during casting but is not sufficiently strong to withstand the contraction forces of the part shrinking during cooling.

25. A component of claim 3, comprising an alloy that is one of:
a) Ti-46Al-8Nb (at. %)
b) Ti-45Al-2Nb-2Mn (at. %) and
c) Ti46Al8Ta (at. %)

26. A method of claim 5, wherein the artificial gravity is at least 50 g.
